(19) United States
(12) Patent Application Publication
(10) Pub. No.: US 2022/0055809 A1
(43) Pub. Date: Feb. 24, 2022

(54) FOOD DELIVERY SAFETY DEVICE

(71) Applicant: Jean E. Polycarpe, Oviedo, FL (US)

(72) Inventor: Jean E. Polycarpe, Oviedo, FL (US)

(21) Appl. No.: 17/406,880

(22) Filed: Aug. 19, 2021

Related U.S. Application Data
(60) Provisional application No. 63/068,465, filed on Aug. 21, 2020.

(51) Int. Cl. B65D 55/14; A47J 47/14; G07C 9/00

(52) U.S. Cl. CPC B65D 55/14; A47J 47/14; G07C 2009/0092; B65D 2203/10; B65D 2251/1016; G07C 9/00896

(57) ABSTRACT

A food delivery safety device includes a main body having a plurality of walls that define an interior space, and a lid that selectively provide access to the interior space. A locking mechanism, access panel, camera and tampering sensors are provided along the main body to detect unauthorized access to the interior space. A controller is located within the main body and includes a wireless communication unit for sending and receiving information with a user device running a food delivery safety application.

### CROSS-REFERENCE TO RELATED APPLICATIONS

This application claims the benefit of U.S. Application Ser. No. 63/068,465 filed on Aug. 21, 2020, the contents of which are incorporated herein by reference.

### TECHNICAL FIELD

The present invention relates generally to food safety products, and more particularly to a device for protecting food from being tampered with during delivery.

### BACKGROUND

The statements in this section merely provide background information related to the present disclosure and may not constitute prior art.

In recent years the number of customers placing telephone or online orders for food delivery has skyrocketed. Although pizza remains the number one food delivery item in the United States, the introduction of third-party food delivery companies has resulted in the ability for almost every restaurant to receive orders for food that will be consumed by the customer at a location other than the restaurants' dining room.

Although food delivery is an extremely attractive option for many individuals who would prefer not to cook, many people are becoming increasingly concerned about the safety of their food items between the time it is prepared and when it is delivered to the customer. Indeed, each year there are increasing reports of unscrupulous individuals tampering with the food they are being paid to deliver. This tampering may involve benign activities such as removing or eating some of the items being delivered or may involve dangerous activities such as introducing poisons intended to harm the end customer.

Accordingly, it would be beneficial to provide a food safety device that can actively monitor food and other such items during a delivery process to ensure the delivered items have not been accessed or otherwise tampered with.

### SUMMARY OF THE INVENTION

The present invention is directed to a food delivery safety device. One embodiment of the present invention can include a main body having a plurality of walls that define an interior space, and a lid that can selectively provide access to the interior space. In one embodiment, a locking mechanism having an access panel can be provided along the main body. Additionally, one or more cameras and sensors can be provided in order to detect unauthorized access to the inside of the main body.

A controller can be located within the main body and can be in communication with the locking mechanism, the access panel, the cameras and the sensors. The controller can include a wireless communication unit for sending and receiving information with a user device running a food delivery safety application.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exemplary operating environment of a food delivery safety device that is useful for understanding the inventive concepts disclosed herein.

FIG. 2 is a perspective view of the food delivery safety device, in accordance with one embodiment of the invention.

FIG. 3 is a simplified block diagram of the controller of the food delivery safety device, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, a “unit” means a series of identified physical components which are linked together and/or function together to perform a specified function.

As described throughout this document, the term “about” “approximately” “substantially” and “generally” shall be used interchangeably to describe a feature, shape or measurement of a component within a tolerance such as, for example, manufacturing tolerances, measurement tolerances or the like.

As described herein, the term “removably secured,” and derivatives thereof shall be used to describe a situation wherein two or more objects are joined together in a non-permanent manner so as to allow the same objects to be repeatedly joined and separated.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the term “connector” includes any number of different elements that work alone or together to repeatedly join two items together in a nonpermanent manner. Several nonlimiting examples include opposing strips of hook and loop material (i.e. Velcro®), attractively-oriented magnetic elements, flexible strips of interlocking projections with a slider (i.e., zipper), a thin, flexible strap with a notched surface and one end threaded through a locking mechanism (i.e., zip tie) at the other, tethers, buckles such as side release buckles, and compression fittings such as T-handle rubber draw latches, hooks, snaps and buttons, for example. Each illustrated connector and complementary connector can be permanently secured to the illustrated portion of the device via a permanent sealer such as glue, adhesive tape, or stitching, for example.

Although described throughout this document for use with delivery of food items, this is for illustrative purposes only to provide but one possible use. As such, the inventive concepts may be utilized to receive, store, and protect any number of different items.

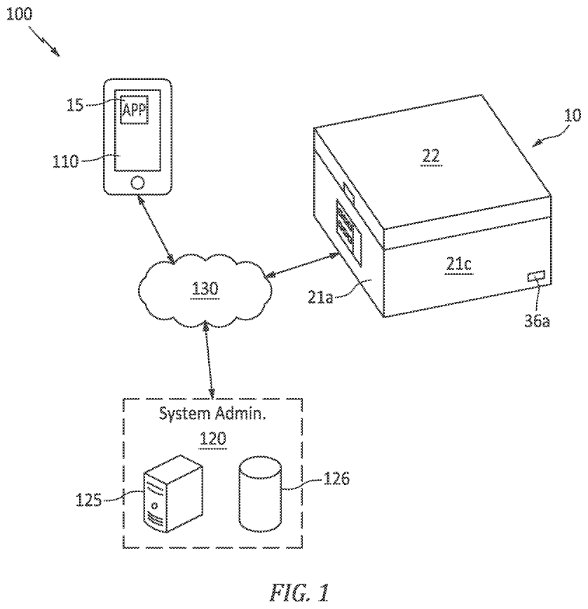

FIGS. 1-3 illustrate one embodiment of a food delivery safety device that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

FIG. 1 is a schematic illustration of an exemplary operating environment 100 for utilizing the food delivery safety device. In one embodiment, the operating environment 100 can include a food delivery safety device 10 that can be in selective communication with a customer interface device 110, and a system administration device 120 over a network 130.

The network 130 can be any type of network, including a cellular network, a local area network (“LAN”), such as an intranet, a wide area network (“WAN”), the internet, and/or any other type of data transmission and reception medium, for example.

The interface device 110 can be any type of computing device that is operable by a human user. A computing device refers to any device with a processor and memory that can execute instructions and communicate with another device. Computing devices include, but are not limited to, computers, smartphones, tablet computers, smartwatches, laptop computers and/or purpose-built machines that are encoded with an application interface, so as to perform the functionality so described. In either instance, a computing device will include one or more client applications, such as a web browser, and/or an application interface, for example, which can allow the device to communicate with other interface devices and/or the system administration 120.

In one embodiment, the system can include a programming code for implementing the system functionality on a smartphone in the form of a mobile application (i.e., App) 15 which can be downloaded and installed onto the user device. As described herein, the mobile application 15 (i.e., food delivery safety application) can be any set of programmatic instructions that can be loaded onto any type of processor enabled device and can include program language for execution on the device that enables a user of the device to interact with the device 10 in order to receive information and/or to lock or unlock the device to permit access to the contents.

The system administration 120, according to one embodiment, can include one or more individual computing devices 125 that can be connected to one or more databases 126 in which various portions of the below described methodology can be performed. In one embodiment, the system administration 120 can function to provide a central hub for controlling the communication between the interface device 110 through any number of different mediums such as a website, a mobile application, or a direct connect audiovisual service such as cellular data, for example. In this regard, one or more of the individual computing devices 125 can include various web servers, email servers, application database servers and so forth.

The database 126 can function to store any type of data, including the system operating instructions for facilitating communication between the device components, routing information and/or generating presentation screens for implementing the below described methodology. To this end, the database can include any type of computer-readable storage mediums, including all forms of volatile and non-volatile memory.

In operation, the system administration may be a food delivery company that is offering the below described functionality to its customers or may be a third party company offering the functionality to customers independently or via a food delivery company.

As described below, one embodiment of the food delivery safety device 10 can include a container having an internal controller 30 for communicating with an external device 110 running an application 15.

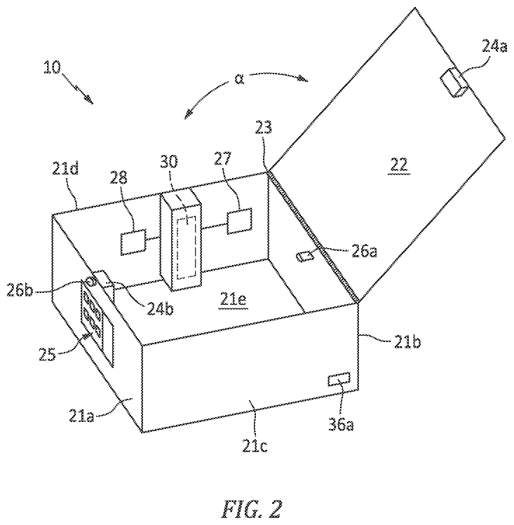

As shown best at FIG. 2, the device 10 can include a main body having a front end 21a, a back end 21b, a pair of sides 21c-21d, and a bottom end 21e that form a hollow interior space. A lid 22 can be secured along one or more sides of the main body via a hinge 23 and can move (see arrow a) to transition the main body between an open position and a closed position.

In one embodiment, the main body and lid can include an internal frame structure made from lightweight aluminum or plastic that is covered with one or more layers of insulated fabric. Such a feature providing a sturdy and lightweight system that will trap heat or cold inside while remaining at or between 5-10 pounds of total weight so as to be easily carried by a delivery worker. Although not illustrated, a handle or handles can be provided along the outside of the main body to aid the delivery worker in carrying the device.

Although described above as including a particular shape and construction material, this is for illustrative purposes only. To this end, the main body and lid can include any number of different shapes and sizes and may be formed in whole or in part from any number of different materials that are, for example, relatively strong for their weight. Several additional nonlimiting examples include but are not limited other types of tear resistant fabrics, various metals or metal alloys (e.g., aluminum, steel, titanium, or alloys thereof), plastic/polymers (e.g., high-density polyethylene (HDPE), rigid polyvinyl chloride (PVC), or polyethylene terephthalate (PET)), and/or various composite materials (e.g., carbon fibers in a polymer matrix, fiberglass, etc.).

In one embodiment, a locking mechanism 24a and 24b can be secured along the lid and main body in order to selectively grant access to the interior of the main body. As will be described below, the device is intended to be locked upon receiving a food item from a restaurant or other location and to remain locked until arriving at the customer location. To this end, the locking mechanism components can be placed anywhere along the main body and/or lid and can preferably include an access panel 25 for operating the locking mechanism.

In the preferred embodiment, the locking mechanism can include an electromechanical lock, and the access panel can include one or more touchscreen devices, a keypad, a biometric sensor, or a nearfield communication sensor, for example. In such an embodiment, the locking mechanism can be communicatively linked to the controller 30 for allowing an end customer to remotely unlock the container using the application 15 on their personal device. Of course, other embodiments are contemplated wherein the locking mechanism and access panel include, comprise or consist of purely mechanical components such as a cam lock having a combination code or key, for example.

In one embodiment, one or more cameras 26a and 26b can be provided along the device body and can function to capture audiovisual information. The cameras can be communicatively linked to the below described controller 30 so as to allow the captured information to be viewed via the end user 110 and/or system administration. In the preferred embodiment, one camera 26a can be oriented toward the inside of the main body to ensure food items stored therein are not accessed during the delivery process, and another camera 26b can be oriented to capture images of the delivery person or other user operating the access panel 25.

In one embodiment, a light 27 can be provided along the inside of the container to provide illumination when the lid is open. The light can be manually activated or can be activated by a sensor switch located in the lock assembly indicating that the lid is open.

In one embodiment, one or more intrusion sensors 28 can be provided along or within the main body. In various embodiments, the intrusion sensors can include motion sensors to detect unauthorized movement of the food stored within the main body, and/or a lid switch that can detect an unauthorized opening of the lid. Such sensors can be communicatively linked to the controller 30.

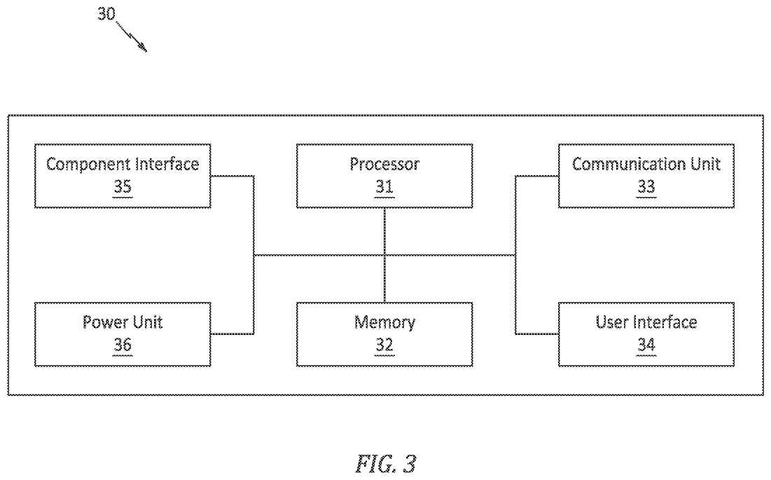

FIG. 3 illustrates one embodiment of a controller 30 which can be positioned within the main body 10. In one embodiment, the controller 30 can include a processor 31 that is conventionally connected to a memory 32, a communication unit 33, a user interface 34, a component interface 35, and/or a power unit 36.

Although illustrated as separate elements, those of skill in the art will recognize that one or more system components may comprise or include one or more printed circuit boards (PCB) containing any number of integrated circuit or circuits for completing the activities described herein. Of course, any number of other analog and/or digital components capable of performing the below described functionality can be provided in place of, or in conjunction with the below described controller elements.

The processor 31 can include one or more central processing units (CPU) or any other type of device, or multiple devices, capable of manipulating or processing information such as program code stored in the memory 32 in order to allow the device to perform the functionality described herein.

The memory 32 can act to store operating instructions in the form of program code for the processor 31 to execute. Although illustrated in FIG. 3 as a single component, memory 32 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device such as a solid-state hard drive, for example.

The wireless communication unit 33 can include any number of discrete or integrated components capable of sending and/or receiving electronic signals with another device, either directly or over a network. In one embodiment, the communication unit 33 can include a cellular transceiver for communicating with a remotely located device such as the user interface device 110 and/or system administrator 120 illustrated at FIG. 1, for example. Of course, the wireless communication unit 33 is not limited to cellular communication, as any number of other communication devices can also be included. Several nonlimiting examples include a WiFi or Bluetooth transceiver for example, that are capable of communicating directly with a user device 110 running a mobile application 15, such as that illustrated at FIG. 1.

In one embodiment, the user interface module 34 can be communicatively linked to the above-described access panel 25, in order to accept user inputs and/or to provide information to a device user. Of course, the user interface can also include or control any number of other buttons, switches or control screens that are connected to the processor so as to activate various components of the device.

The component interface 35 can function to provide a communicative link between the processor 31 and various system elements such as the cameras 26a-26b, the light 27 and/or the intrusion sensor(s) 28, for example. In this regard, the component interface unit can include any number of different components such as one or more PIC microcontrollers, bus cables, and/or cable connectors (e.g., com port, USB port), among other types of known communication hardware capable of engaging any number of communication cables and device(s).

In one embodiment, the power unit 36 can include one or more batteries capable of providing the necessary power requirements to each element of the device 10. In one embodiment, the batteries can be permanently located within the main body and can be rechargeable in nature via a charging port 36a, such as a mini or micro USB port, for example. Of course, traditional batteries can also be utilized, and the main body can further include a battery compartment having a removable cover (not illustrated) for allowing a user to access the same.

In operation, the device 10 can be operated whereby food or other such items are placed within the main body at a restaurant. Upon closing the lid, the locking mechanism can secure the device in the closed position and the cameras and sensors can begin operating throughout the delivery process. Upon arriving at a customer's location, the customer can be notified by the mobile application, and they can view the camera and sensor information to ensure their products have not been tampered with. Finally, the customer can remotely unlock the container by the mobile application and retrieve the contents and/or can unlock the container using the access panel 25 via a pin that is provided to the user directly.

As described herein, one or more elements of the food delivery safety device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. a food delivery safety device, comprising:
a main body having a plurality of walls that define an interior space;
an opening disposed along the main body;
a lid that is hingedly secured to one of the plurality of walls, said lid being configured to transition between an open position and a closed position;
a locking mechanism that is disposed along the main body, said locking mechanism being configured to selectively lock the lid in the closed position; and
an access panel that is communicatively linked to the locking mechanism, said access panel including functionality for controlling an operation of the locking mechanism.

2. The device of claim 1, further comprising:
a controller having a wireless communication unit that is configured to send and receive information with an external device.

3. The system of claim 2, wherein the wireless communication unit includes at least one of a cellular transceiver, a Bluetooth transceiver or a WiFi transceiver.

4. The device of claim 2, wherein the controller is communicatively linked to the locking mechanism.

5. The device of claim 4, wherein the controller includes functionality for selectively locking and unlocking the locking mechanism based upon a received signal from the communication unit.

6. The device of claim 2, further comprising:
a lid sensor that is configured to detect an unauthorized movement of the lid.

7. The device of claim 6, wherein the communication unit includes functionality for sending a notification to an external device upon receiving an alarm condition by the lid sensor.

8. The device of claim 2, further comprising: a biometric sensor that is configured to selectively operate the locking mechanism.

9. The device of claim 2, further comprising:
a food delivery safety application, said application comprising machine readable instructions for execution on a computing device having a processor, a memory, and a display screen,
wherein the application includes functionality for communicating with the wireless communication unit to selectively operate the locking mechanism.
